(19) United States
(12) Patent Application Publication
(10) Pub. No.: US 2026/0052500 A1
(43) Pub. Date: Feb. 19, 2026

(54) Network-Based Positioning in Non-Terrestrial Networks

(71) Applicant: Apple Inc., Cupertino, CA (US)

(72) Inventors: Zhibin Wu, Los Altos, CA (US); Dawei Zhang, Saratoga, CA (US); Yuqin Chen, Beijing (CN); Ajay Panchal, San Diego, CA (US); Chunxuan Ye, San Diego, CA (US); Naveen Kumar R Palle Venkata, San Diego, CA (US); Fangli Xu, Beijing (CN); Haijing Hu, Los Altos, CA (US); Sarma V Vangala, Campbell, CA (US); Jie Cui, San Jose, CA (US)

(21) Appl. No.: 19/100,504

(22) PCT Filed: Aug. 10, 2022
(86) PCT No.: PCT/CN2022/111386

§ 371 Date: Jan. 31, 2025

(51) Int. Cl. H04W 64/00; H04B 17/20; H04L 5/00

(52) U.S. Cl. CPC H04W 64/00; H04B 17/254; H04L 5/0048

(57) ABSTRACT

Apparatuses, systems, and methods for UE location determination in a non-terrestrial network (NTN), e.g., in 5G NR systems and beyond. A network entity, such as base station and/or location management function, may be configured to transmit, to a UE, a location request. The network entity may be configured to receive, from the UE, at least one report associated with UE location. The at least one report may include Reference Signal Time Difference (RSTD) measurements of at least two DL-PRS transmissions and/or three or more reports (e.g., each report of the three or more reports may include a RSTD measurement. Further, the network entity may be configured to derive and/or calculate, based on the at least one report, UE location.

### FIELD

The invention relates to wireless communications, and more particularly to apparatuses, systems, and methods for network-based positioning in non-terrestrial networks, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized. 5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for network-based positioning in non-terrestrial networks, e.g., in 5G NR systems and beyond.

For example, in some embodiments, a network entity, e.g., such as base station and/or LMF, may be configured to transmit, to a UE, a location request. The network entity may be configured to receive, from the UE, at least one report associated with UE location. The at least one report may include Reference Signal Time Difference (RSTD) measurements of at least two DL-PRS transmissions and/or three or more reports (e.g., each report of the three or more reports may include a RSTD measurement. Further, the network entity may be configured to derive and/or calculate, based on the at least one report, UE location.

As another example, in some embodiments, a network entity, e.g., such as base station and/or LMF, may be configured to transmit, to a UE, a timing advance report configuration. The timing advance report configuration may include satellite location information and/or timing information requirements for at least one timing advance report (e.g., such as periodicity and/or an offset). The network entity may be configured to receive, from the UE, at least one timing advance report. The at least one timing advance report may be comprised and/or included in a medium access control (MAC) control element (CE) and may include three or more timing advance reports. The network entity may be configured to derive and/or calculate, based on the at least one timing advance report, UE location.

As a further example, in some embodiments, a UE, may be configured to receive, from a network entity, e.g., such as a base station and/or LMF, a location request. The UE may be configured to measure signals from at least one satellite. The UE may be configured to transmit, to the network entity, at least one report based on the measuring of the signals and associated with UE location. The at least one report may include three or more RSTD measurements, three or more reports (e.g., each report of the three or more reports may include an RSTD measurement), RSTD measurements from at least three satellites, and/or three or more timing advance reports.

As a yet further example, a UE may be configured to receive, from a network entity, e.g., such as a base station and/or LMF, a timing advance report configuration. The timing advance report configuration may include satellite location information and/or timing information requirements (e.g., periodicity and/or an offset) for at least one timing advance report. The UE may be configured to transmit, to the network entity, at least one timing advance report. The at least one timing advance report may be comprised and/or included in a medium access control (MAC) control element (CE). The at least one timing advance report may include three or more timing advance reports.

The techniques described herein may be implemented in and/or used with a number of different types of devices, including but not limited to unmanned aerial vehicles (UAVs), unmanned aerial controllers (UACs), unmanned arial systems (UASs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates an example of signaling for a base station to calculate a location of a UE in an NTN network, according to some embodiments.

FIG. 9 illustrates an example of signaling for an LMF of a network to calculate a location of a UE in an NTN network, according to some embodiments.

FIG. 10 illustrates another example of signaling for an LMF of a network to calculate a location of a UE in an NTN network, according to some embodiments.

FIG. 11 illustrates a further example of signaling for an LMF of a network to calculate a location of a UE in an NTN network, according to some embodiments.

FIG. 12 illustrates an example of time and space diversity for DL-PRSs, according to some embodiments.

FIGS. 13, 14, 15, and 16 illustrate block diagrams of examples of methods for determining UE location in an NTN, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
CBRS: Citizens Broadband Radio Service
DAS: Distributed Antenna System
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
CSI-RS: Channel State Information Reference Signal
PDCCH: Physical Downlink Control Channel.
PDSCH: Physical Downlink Shared Channel
RRC: Radio Resource Control
RRM: Radio Resource Management
CORESET: Control Resource Set
TCI: Transmission Configuration Indicator
DCI: Downlink Control Indicator

### Terms

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel-a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

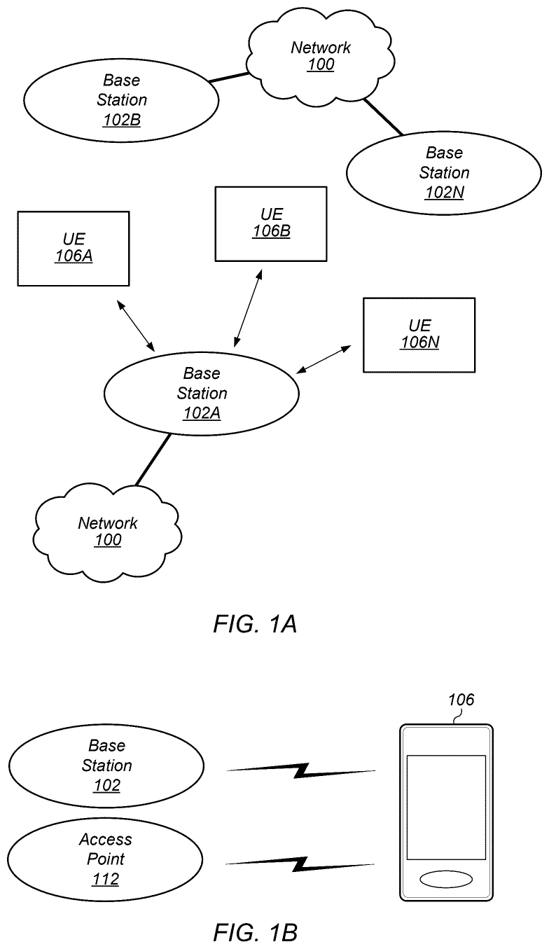

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, CHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, cHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/CHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTTor LTE or GSM), and separate radios for communicating using each of Wi-Fi and Bluetooth. Other configurations are also possible.

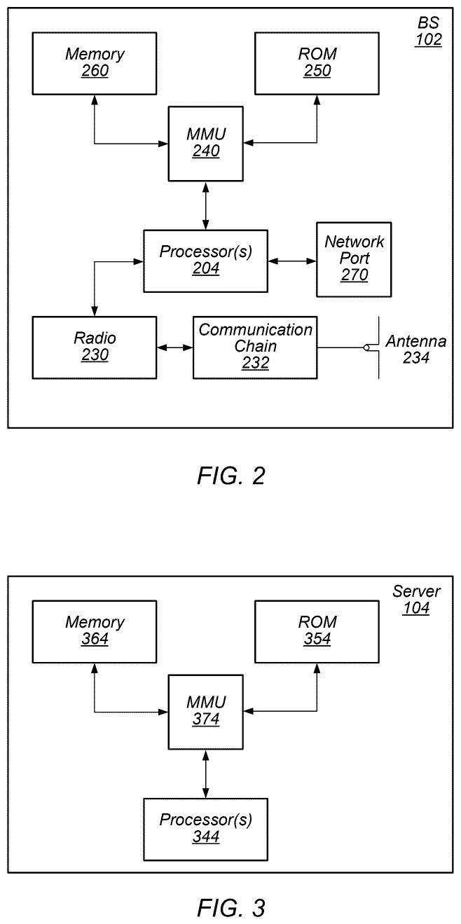

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

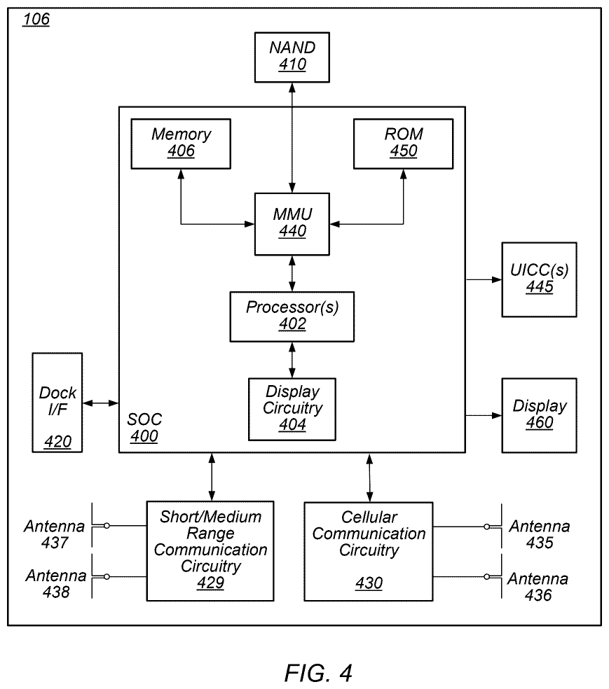

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown.

Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more CUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (CUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for revocation and/or modification of user consent in MEC, e.g., in 5G NR systems and beyond, as further described herein.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

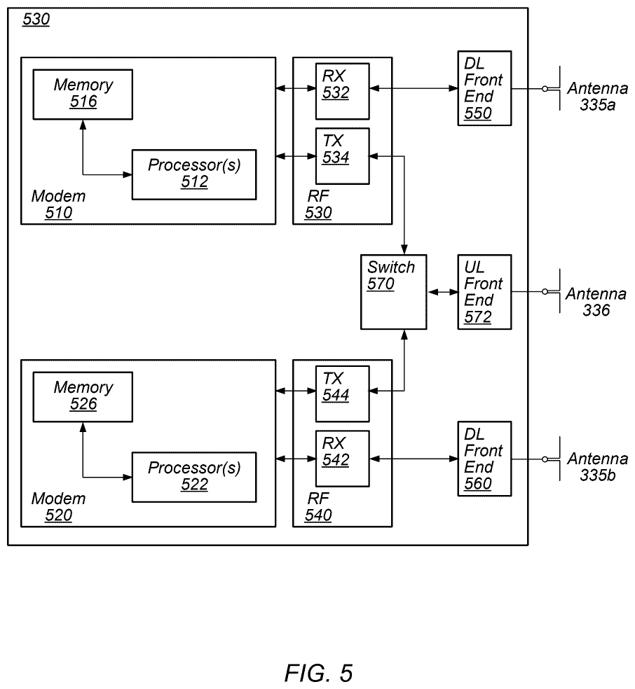

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for network-based positioning in non-terrestrial networks, e.g., in 5G NR systems and beyond, as further described herein. For example, the cellular communication circuitry 530 may be configured to perform methods for CORESET #0 configuration, SSB/CORESET #0 multiplexing pattern 1 for mixed SCS, time-domain ROs determination for 480 kHz/960 KHz SCSs, and RA-RNTI determination for 480 kHz/960 kHz SCSs.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for communicating a scheduling profile for power savings to a network, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

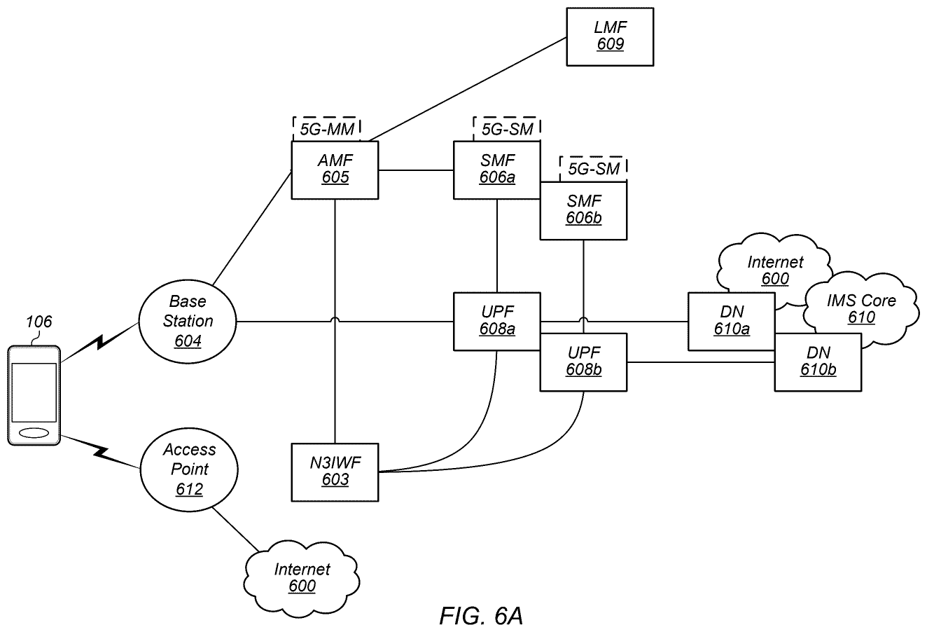

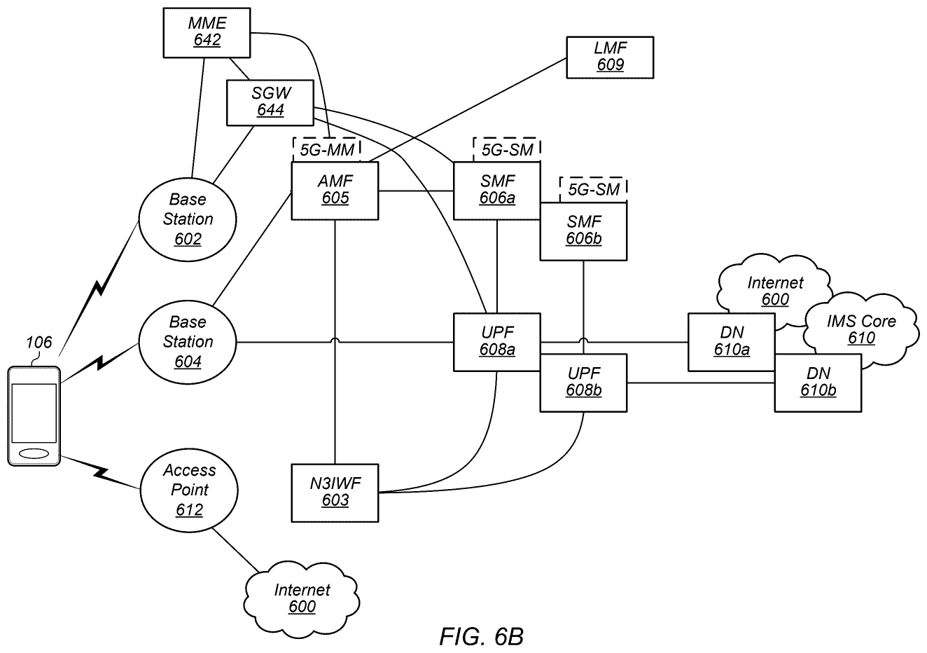

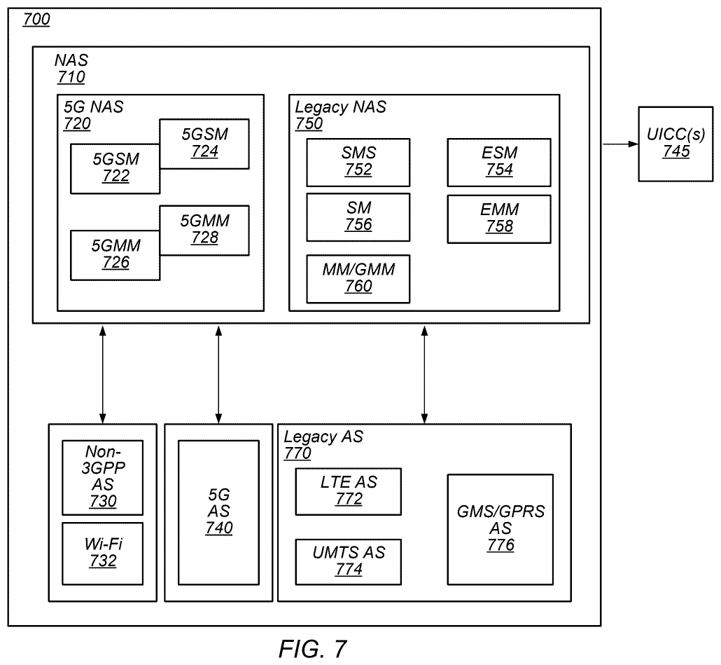

FIGS. 6A, 6B and 7: 5G Core Network Architecture-Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with a location management function (LMF) 609 via a networking interface, such as an NLs interface, e.g., as described above, and may include functional entities associated with the 5G CN. Note that these functional entities may also be supported by the SMF606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods to improve security checks in a 5G NR network, including mechanisms for network-based positioning in non-terrestrial networks, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for network-based positioning in non-terrestrial networks, e.g., in 5G NR systems and beyond, e.g., as further described herein.

Network-based positioning in Non-terrestrial Networks

In current implementations, cellular systems, e.g., such as 5G NR systems, may be configured to use a satellite (or unmanned arial system (UAS) platform) as an antenna in a non-terrestrial network (NTN) architecture. In such instances, the satellite may be considered transparent and may not generate date (e.g., the satellite may not encode and/or decode data). In such instances, there is not direct communication between a UE and a base station. Thus, it becomes difficult for a network to determine the UE's position without aid from the UE. In other words, in current NTN implementations, there are no mechanisms for a network to determine a UE's position upon initial access to the system via a satellite. For example, during initial access, a UE may provide, with specific user consent, its coarse global navigation satellite systems (GNSS) location to the network while in a connected state, e.g., after security establishment. However, without specific user consent, the UE may not provide its GNSS location.

Thus, in some implementations, a network may use downlink (DL) time difference of arrival (TDOA) to locate a UE, e.g., when base stations are tightly synchronized. For example, multiple base stations may transmit a positioning reference signal (PRS) to a UE. The UE may then make time of arrival (TOA) measurements from the received PRSs. The UE may then calculate TDOAs from each base station by subtracting the TOA of a reference base station from observed TOAs from other base stations. Geometrically, a received signal time difference (RSTD), e.g., the time difference between receiving PRSs from multiple base stations, with respect to two base stations determines a hyperbola between the two base stations and a point of intersection between these hyperbolas determine the UE's location.

In other implementations, a multiple round-trip time (multi-RTT) mechanism may be used. One advantage of such a mechanism is that RTT does not require stringent (e.g., tight synchronization) among base stations. An RTT procedure can be initiation by either a UE or a base station. For example, in a network model to determine UE location, the RTT procedure may begin with the UE (e.g., initiating device) sending sounding reference signals (e.g., an uplink (UL) PRS) to multiple base stations. Each base station may measure a TOA relative to its own timing. Further, each base station may then send a sounding reference signal back to the UE, including the TOA relative to its own timing and time of departure (TOD) of the sounding reference signal (e.g., DL PRS). The UE may then measure a TOA of the each received sounding reference signal and determine a distance between the UE and each base station. The network may receive the distance information from the UE and use distance from the UE to each base station along with the location of each base station to determine a location of the UE, e.g., using a multi-lateration method.

In addition, the network may derive a propagation delay between the UE and a satellite using a timing advance (TA) report and the propagation delay between the base station and the satellite. For example, TA may be calculated based on equation [1]:

$${T}_{TA} = {T}_{C} ( {N}_{TA} + {N}_{TA , UE - specific} + {N}_{TA , common} + {N}_{TA , offset} ) \qquad [ 1 ]$$

where,
N_{TA} is defined as 0 for PRACH and updated based on a TA command field in msg2/msgB and MAC CE TA command;
N_{TA,UE-specific} is a UE self-estimated TA to pre-compensate for a service link delay;
N_{TA,common} is a network-controlled common TA and may include any timing offset considered necessary by the network (may have a value of 0);
N_{TA,offset} is a fixed offset used to calculate the timing advance; and
T_{C} is 5G NR sampling rate.

Turning to NTN networks, the above-described mechanisms present various challenges with respect to UE location determination. For example, in general, received signal strength and angular measurements such as angle of arrival are no longer useful measurements for a long-distance satellite link, e.g., because the relative distance between UEs is inconsequential as compared to the distance between the satellite and UEs, thus received signal strength and angle of arrival are similar across a coverage area of the satellite. Further, current terrestrial networks use various “triangulation” techniques to estimate UE location and accuracy. However, with NTNs, there are not typically multiple transmit points covering the same area. In other words, the assumption for NTNs has been that only one beam (satellite) is used to cover a cell at any given time. Hence, the UE has only one serving satellite at a time and triangulation is not available.

Thus, with respect to NTN deployments, DL-TDOA (e.g., which requires synchronized base stations transmitting DL-PRS and the UE providing time differentials to the network) may be possible for NTN but requires multiple satellites in view and may suffer from the large propagation delay that may lead to receiving measurement uncertainty. Further, Multi-RTT (e.g., which requires calculating a timing difference between DL-PRS and UL-SRS from multiple transmit points), may also be possible for NTN but, like DL-TDOA, requires multiple satellites in view and may suffer from the large propagation delay that may lead to receiving measurement uncertainty as well as challenges for UL-SRS signal transmissions to reach multiple satellites at the same time. In addition, DL-AoD (e.g., where base stations transmit DL-PRSs with beam sweeping and a UE measures the RSRP/RSRQ for each beam based on the beamformed DL-PRS and uses these quality measurements to estimate AoDs), may also be possible for NTN but, like DL-TDOA, requires multiple satellites in view and may suffer from the large propagation delay that may lead to receiving measurement uncertainty as well as angle-based measurements in NTNs may not provide sufficient accuracy for UE location calculations. Therefore, improvements are desired.

Embodiments described herein provide systems, methods, and mechanisms to support network derivation of UE location in non-terrestrial networks (NTNs). For example, embodiments may include systems, methods, and mechanisms for deriving UE location from timing advance (TA) reports as well as deriving UE location based on network transmitted positioning reference signals from single or multiple satellites. For example, in some embodiments, a network may calculate a location of a UE based on a UE's TA report. As another example, in some embodiments, a network may calculate a location of a UE based on DL-PRS signals from multiple satellites in view which may be suitable for geostationary (GEO) satellites. As a further example, in some embodiments, a network may calculate a location of a UE based on DL-PRS signals from a single satellite in view, which may be suitable for non-geostationary (NGSO) satellites. As a yet further example, a network may calculate a location of a UE based on DL-PRS signals from both GEO and NGSO satellites, which may allow for both spatial and time diversity in location measurements.

In some instances, a network may derive a location of a UE based on a UE's reported timing advance (TA) pre-compensation in a series of TA reports. For example, a UE, such as UE 106, may send multiple TA reports to the same base station (e.g., on and/or behind the same satellite). The satellite may move at a constant velocity according to its ephemeris and the UE may report different TA(s) based on its location (which may be static) and different satellite locations (e.g., satellite location may be broadcasted in system information blocks (SIBs)) or derived based on the satellite's ephemeris). In addition, a propagation delay may be translated to a distance and/or range. Further, any uncertainty of UE-side processing delay and/or drifting error may be eliminated by a delta timing advance (e.g., ΔTA=TA1−TA2). Note that to resolve a location (e.g., a position (x, y, z)) on earth, at least 3 TA reports are required and additional reports may increase location accuracy. Note further that, theoretically, there are two solutions in three-dimensional space given a single satellite orbit, but it is impossible that those two solutions are both on the earth's surface for NGSO satellites. However, for GEO satellites orbiting earth around a longitude, there are always two symmetric on earth locations which can satisfy the calculation. Thus, the network may rely on other information to eliminate this ambiguity. For example, the network may rely on terrestrial/geographical information of the UE. As another example, the satellite may guide (or direct) its beam (cell coverage) to only cover one side of its orbit. As a further example, a single satellite may adopt multiple orbits in ephemeris, such that all its locations are not in the same plane.

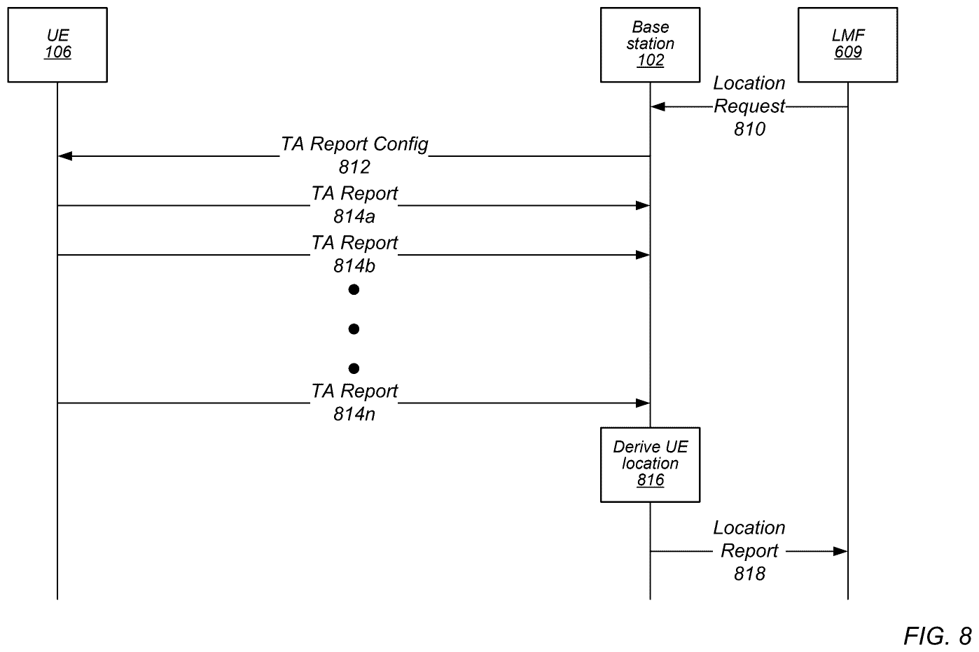

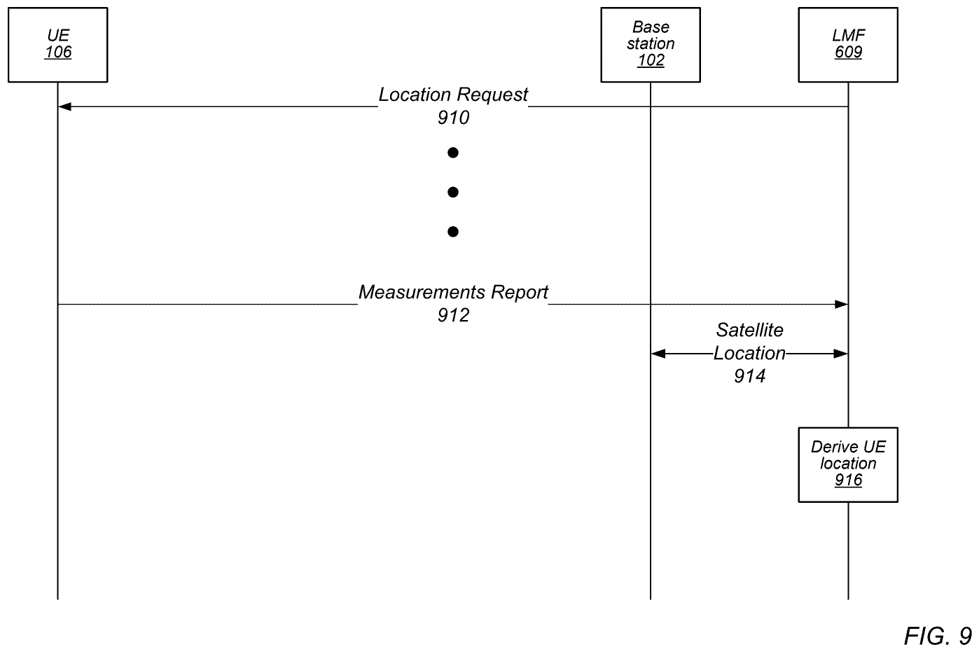

For example, in some instances, e.g., as illustrated by FIG. 8, a base station may calculate a location of a UE and report the location of the UE to a location server, e.g., such as a Location Management Function (LMF). In such instances, the base station may include satellite location information in a configuration message to the UE to aid the UE in calculating a TA without the need to read system information (SI) or ephemeris information of the satellite. Additionally, the base station may include timing information requirements (e.g., such as periodicity and/or offset) for TA reporting. Further, a TA report MAC control element (CE) as defined in 3GPP Release 17 may be used to report the TA. As another example, in some instances, e.g., as illustrated by FIG. 9, a UE may report TA and/or RTT measurements to an LMF via the LTE positioning protocol (LPP). The LMF may use a NR positioning protocol A (NRPPa) procedure to obtain satellite orbit/location information from a base station. Additionally, the LMF may calculate a location of the UE based on the measurements and information.

Turning to FIG. 8, FIG. 8 illustrates an example of signaling for a base station to calculate a location of a UE in an NTN network, according to some embodiments. The signaling shown in FIG. 8 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

As shown, a location management function (LMF) server, e.g., such as LMF 609, may send a location request 810 to a base station, such as base station 102 (e.g., via an interface to an AMF, such as AMF 605). The LMF 609 may be a server (e.g., such as server 104) and/or functional entity located within a network (e.g., within a core network). The server/functional entity may include at least a processor and a memory. In some instances, the server/functional entity may include a network interface. Upon receiving the location request 810, the base station may transmit, to a UE, such as UE 106, a timing advance (TA) report configuration 812. The TA report configuration 812 may include satellite location information. Thus, the UE 106 may not be required to detect system information and or ephemeris information broadcast via satellite in communication with the base station and UE. In some instances, the TA report configuration 812 may additionally include information associated with requirements of the TA report, e.g., such as periodicity and/or offset. The UE may then perform multiple TA measurements for the satellite and report the TA measurements to the base station via TA reports 814a-n. Thus, the UE may report different TA measurements based on its own location (e.g., own static location) and different satellite locations (e.g., as the satellite moves/orbits about its ephemeris). Note that the UE may receive updates of the satellites position via a system information block (SIB) broadcast by the satellite and/or as part of the TA report configuration 112. At 816, the base station may derive the location of the UE based on the TA reports 814a-n. Further, the base station may send a location report 818 to the LMF to update the UE's location at the LMF.

Turning to FIG. 9, FIG. 9 illustrates an example of signaling for an LMF of a network to calculate a location of a UE in an NTN network, according to some embodiments. The signaling shown in FIG. 9 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

As shown, a location management function (LMF) server, e.g., such as LMF 609, may send a location request 910 to a UE, such as 106 (e.g., via an interface to an AMF, such as AMF 605). The LMF 609 may be a server (e.g., such as server 104) and/or functional entity located within a network (e.g., within a core network). The server/functional entity may include at least a processor and a memory. In some instances, the server/functional entity may include a network interface. Upon receiving the location request 910, Upon receiving the location request 910, the UE may then perform multiple TA measurements and/or RTT (round trip time) measurements for a satellite in communication with the UE and a base station, such as base station 102. The UE may then report the measurements to the LMF via measurement report 912. Note that the UE may receive updates of the satellites position via a system information block (SIB) broadcast by the satellite. Additionally, the LMF may send communication with the base station at 914 to determine satellite locations associated with the measurements report. At 916, the LMF may derive the location of the UE based on the measurements report 912 and the satellite location information.

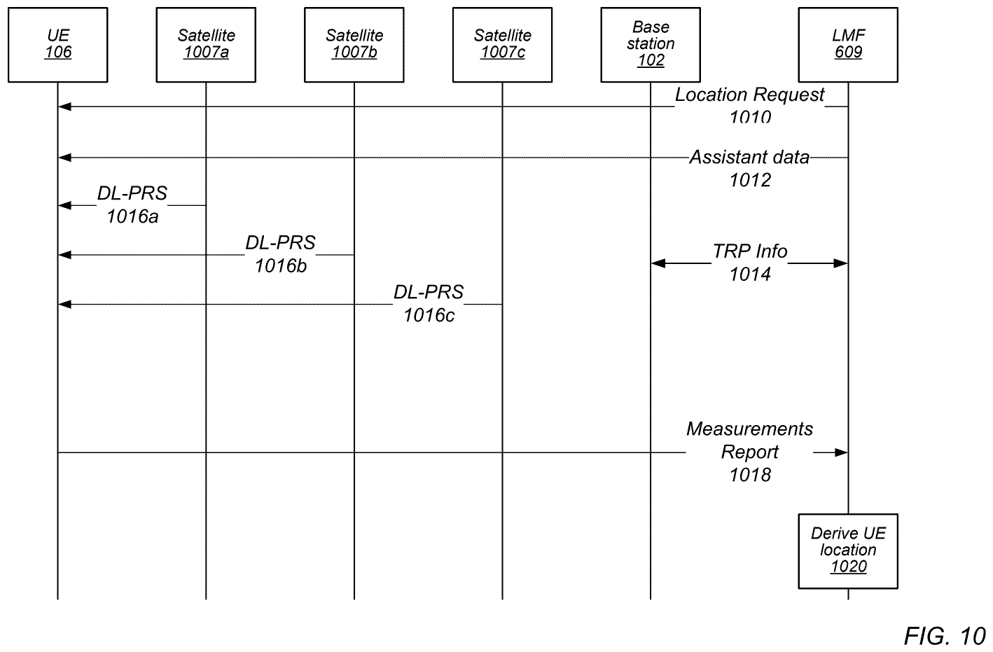

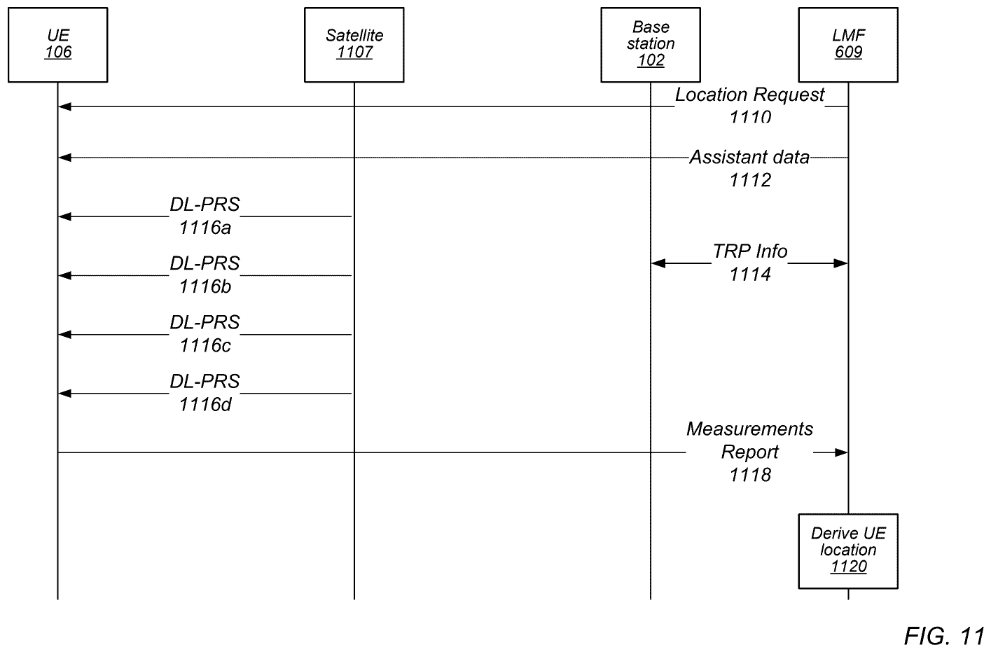

In some instances, a network may require an alternative method to obtain/derive location of the UE, e.g., a RAT dependent method. In some instances, an NTN radio access network (RAN) may provide positioning reference signals (PRSs) from transmit-receive points (TRPs). The UE may then provide PRS measurements. The network may then derive the location of the UE based on the UE measurements of PRS and location/configuration of the TRPs. For example, in some embodiments, e.g., as illustrated by FIG. 10, at least three satellites may be configured to cover a common area with respective directional beams. Each satellite may transmit a synchronous downlink PRS (DL-PRS) signal. The UE may receive and measure each DL-PRS and transmit a measurement report to an LMF of the NTN RAN. Note that the LMF may need to obtain movement information of the TRPs (e.g., satellite ephemeris) in order to derive a location of the UE. In some instances, a satellite may transmit PRSs to an area that extends beyond its core serving area. In this manner, the satellite may have a service area and an extended area beyond its service area. Further, within its service area, the satellite may be responsible for both paging and receiving RACH as well as other UL/DL traffic. Additionally, within the extended area, the satellite may only be responsible for transmitting DL-PRS and may not be able to receive any uplink signals. Thus, a UE may receive DL PRSs from multiple satellites while remaining in only a single satellite's service area. As another example, in some embodiments, e.g., as illustrated by FIG. 11, based on moving coordinates of a satellite and a UE report of very fine timing of a time difference of the reception of DL-PRS signals from the same satellite, a distance to the UE may be derived and a location of the UE may be at least partially solved. In some instances, a UE may need to report its movement (e.g., velocity) to aid an LMF in eliminating the impact of the UE's mobility to improve positioning accuracy. In some instances, assistance data may indicate a time sequence for the UE to measure DL-PRS sequentially. Further, to generate at least three valid (RSTD) measurements, at least four different DL-PRS transmissions are needed. In some instances, the UE may report a measurements report after collection of enough (e.g., at least four) measurements. Alternatively, in some instances, the UE may report a measurement report each time an RSTD is derived between two sequential DL-PRS transmissions from the same transmit-receive point (TRP) or the same satellite. In some instances, as a transmission timing gap of two sequential DL-PRS transmissions are already known by the network (e.g., the LMF), the UE's RSTD report can subtract those known differences and only report the delta of a timing difference in reception caused by satellite movement and/or by the UE's own movement.

Turning to FIG. 10, FIG. 10 illustrates another example of signaling for an LMF of a network to calculate a location of a UE in an NTN network, according to some embodiments. The signaling shown in FIG. 10 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

As shown, a location management function (LMF) server, e.g., such as LMF 609, may send a location request 1010 to a UE, such as 106 (e.g., via an interface to an AMF, such as AMF 605). The LMF 609 may be a server (e.g., such as server 104) and/or functional entity located within a network (e.g., within a core network). The server/functional entity may include at least a processor and a memory. In some instances, the server/functional entity may include a network interface. Further, the LMF 609 may send assistance data 1012 to the UE. The assistance data may include a configuration of DL-PRS for one or multiple satellites, e.g., such as satellites 1007a-c. In addition, the LMF 609 may communicate with a base station, such as base station 102, to obtain TRP information 1014 associated with the satellites 1007a-c (e.g., such as ephemeris data for each satellite). Additionally, upon receiving the location request 1010 and assistance information 1012, the UE may receive DL-PRS 1016a from satellite 1007a, DL-PRS 106b from satellite 1007b, and DL-PRS 106c from satellite 1007c. The UE may perform measurements on each received DL-PRS and transmit a measurements report 1018 to the LMF 609. At 1020, the LMF may derive the location of the UE based on the measurements report 1018 and the satellite location information.

Turning to FIG. 11, FIG. 11 illustrates a further example of signaling for an LMF of a network to calculate a location of a UE in an NTN network, according to some embodiments. The signaling shown in FIG. 11 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

As shown, a location management function (LMF) server, e.g., such as LMF 609, may send a location request 1110 to a UE, such as 106 (e.g., via an interface to an AMF, such as AMF 605). The LMF 609 may be a server (e.g., such as server 104) and/or functional entity located within a network (e.g., within a core network). The server/functional entity may include at least a processor and a memory. In some instances, the server/functional entity may include a network interface. Further, the LMF may send assistance data 1112 to the UE. The assistance data may include a configuration of DL-PRS for at least one satellite, e.g., such as satellite 1107. In addition, the LMF 609 may communicate with a base station, such as base station 102, to obtain TRP information 1114 associated with the satellite 1107 (e.g., such as ephemeris data for each satellite). Additionally, upon receiving the location request 1110 and assistance information 1112, the UE may receive DL-PRSs 1116a-d from satellite 1107. The UE may perform measurements on each received DL-PRS and transmit a measurements report 1118 to the LMF 609. At 1120, the LMF may derive the location of the UE based on the measurements report 1118 and the satellite location information.

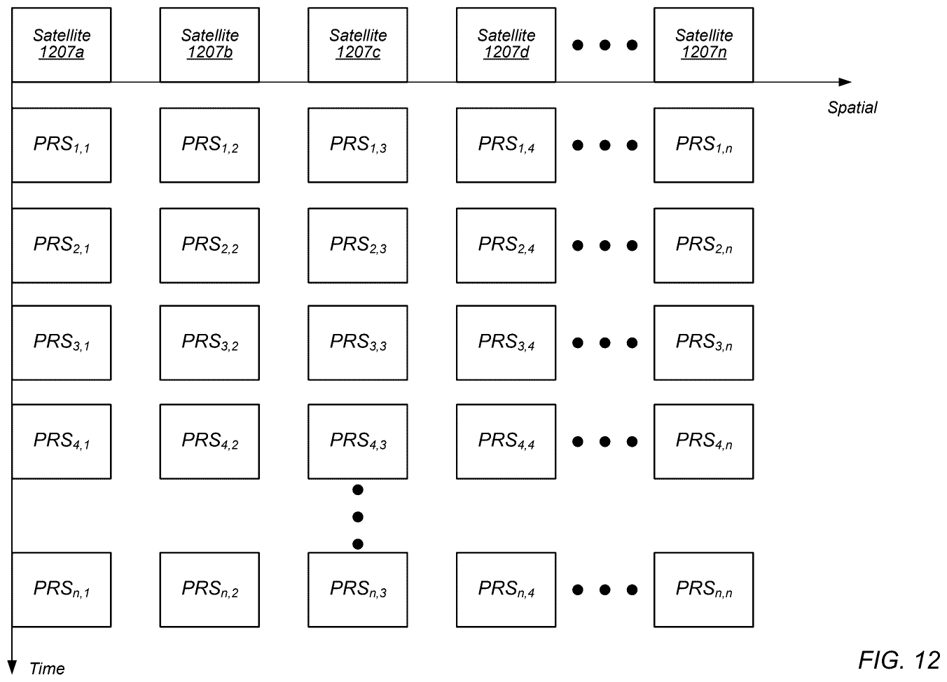

As noted above, to locate a UE, such as UE 106, sufficient DL-PRSs transmitted from multiple TRPs is needed (e.g., as illustrated in FIG. 10). However, when a number of satellites in view is limited, the UE may need to consider how to receive sufficient DL-PRS beams for positioning. For example, with only 2 satellites in view, the UE may rely on at least one of the satellites to transmit DL-PRSs sequentially in different locations of the orbit (e.g., as illustrated in FIG. 11). Thus, in some embodiments, location of the UE may be determined in a hybrid manner, e.g., using DL-PRSs from multiple satellites as well as DL-PRSs transmitted from one satellite, e.g., as shown in FIG. 12, satellites 1207a-n may transmit PRSs sequentially in time. Thus, PRS_{S}_{_{1,1-n,n}} may have diversity in both time and space thereby allowing a UE to receive sufficient PRSs for an LMF to derive its location. In some instances, instead of assuming DL-PRS are broadcast periodically, DL-PRS transmissions may be configured for transmission once or a few times and different DL-PRS configurations may linked in the time domain with offsets. Thus, instead of having a constant reference TRP, PRS measurements may be reported without the use of a timing differential to the reference TRP. Instead, TRP identifiers (IDs) may be used by the LMF to derive time differences. Note that a reference TRP may not be designated in assistance data since the satellite in view for a UE may continue to change, thus, it may be more convenient to not have a fixed reference TRP.

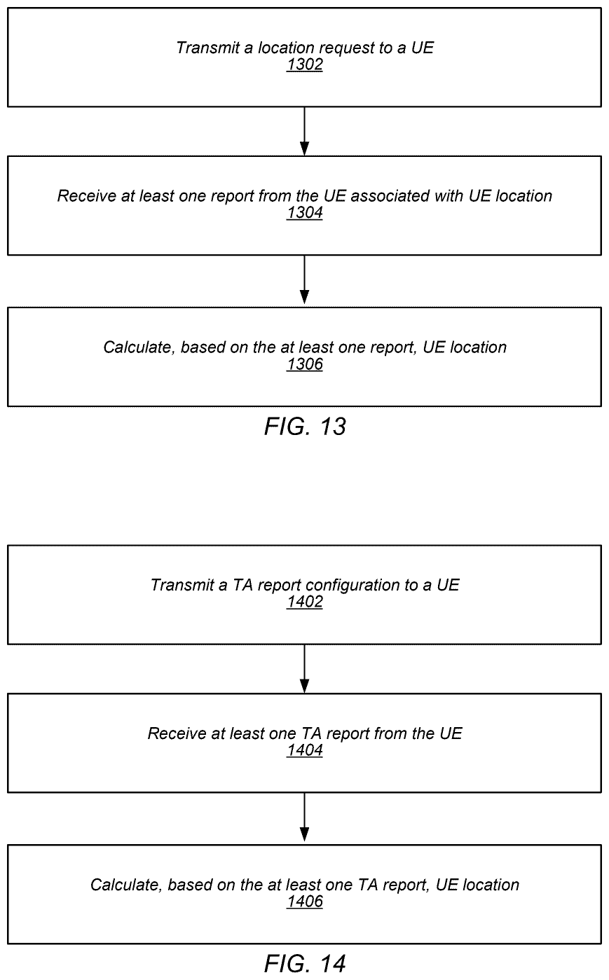

FIG. 13 illustrates a block diagram of an example of a method for determining UE location in a non-terrestrial network (NTN), according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1302, a network entity, e.g., such as base station 102 and/or LMF 609, may transmit, to a UE, such as UE 106, a location request. The network entity may communication with the UE via a link supported by one or more of a satellite relay and/or an interface to an AMF of a core network.

At 1304, the network entity may receive, from the UE, at least one report associated with UE location. In some instances, the at least one report may include Reference Signal Time Difference (RSTD) measurements of at least two DL-PRS transmissions. In some instances, the RSTD measurements may be based, at least in part, on a timing difference of the two DL-PRS transmissions. In some instances, the DL-PRS transmissions may be received from one satellite (e.g., the same satellite) and/or one transmit-receive point (TRP) (e.g., the same TRP). In some instances, the at least one report may include three or more reports. In such instances, each report of the three or more reports may include a Reference Signal Time Difference (RSTD) measurement. In some instances, the at least one report may include UE mobility information.

At 1306, the network entity may derive and/or calculate, based on the at least one report, UE location.

In some instances, the network entity may transmit, to the UE, assistance data. The assistance data may indicate a time sequence for the UE to measure downlink position reference signals (DL-PRSs). In some instances, e.g., for NTN-based positioning, the assistance data may be required to provide different configurations which are suitable for satellite TRPs. For example, except GEO satellites, TRPs on a satellite are constantly moving, therefore, for a DL-PRS configuration, it may be valid for only a short time window for a UE to measure. In other words, the DL-PRS configuration is only associated with a short time period for the UE measurement and is not intended to be measured by the UE periodically, e.g., since the TRP transmitting this DL-PRS is not stationary and may not be able to reach the UE after a time period. Therefore, the time periods associated with the DL-PRS configurations may be sequential in the time domain. In some instances, the DL-PRS configurations from the same TRP may need to have a proper gap in the timing sequence so that UE reported measurements can be unambiguously associated with the corresponding transmission of a DL-PRS. In some instances, e.g., when the DL-PRS are transmitted too frequently, it may be difficult for an LMF to identify the RSTD measurements' relationship to the DL-PRS transmission(s). Thus, in some instances, the time sequence may include, for each configured DL-PRS transmission, a valid time period of the UE to measure an associated DL-PRS.

In some instances, the network entity may increase UE location accuracy based, at least in part, on incorporating UE mobility information into the derivation/calculation of UE location.

In some instances, the at least one report may include RSTD measurements from at least three satellites. In such instances, the network entity may request, from a base station, transmit receive point (TRP) information and receive, from the base station, the TRP information. The TRP information may include satellite ephemeris information for each of the at least three satellites.

In some instances, the at least one report may include three or more timing advance reports. In such instances, the network entity may request, from a base station, satellite location information. Additionally, deriving/calculating the UE location may be further based, at least in part, on the satellite location information.

FIG. 14 illustrates a block diagram of another example of a method for determining UE location in a non-terrestrial network (NTN), according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1402, a network entity, e.g., such as base station 102 and/or LMF 609, may transmit, to a UE, such as UE 106, a timing advance report configuration. The timing advance report configuration may include satellite location information. In addition, the timing advance report configuration may include timing information requirements for at least one timing advance report. The timing information requirements may include one or more of a periodicity or an offset.

At 1404, the network entity may receive, from the UE, at least one timing advance report. The at least one timing advance report may be comprised and/or included in a medium access control (MAC) control element (CE). In some instances, the at least one timing advance report may include three or more timing advance reports.

At 1406, the network entity may derive and/or calculate, based on the at least one timing advance report, UE location.

In some instances, the network entity may receive, from an LMF, a location request. In addition, the network entity may transmit, to the LMF after deriving/calculating the UE location, a location report.

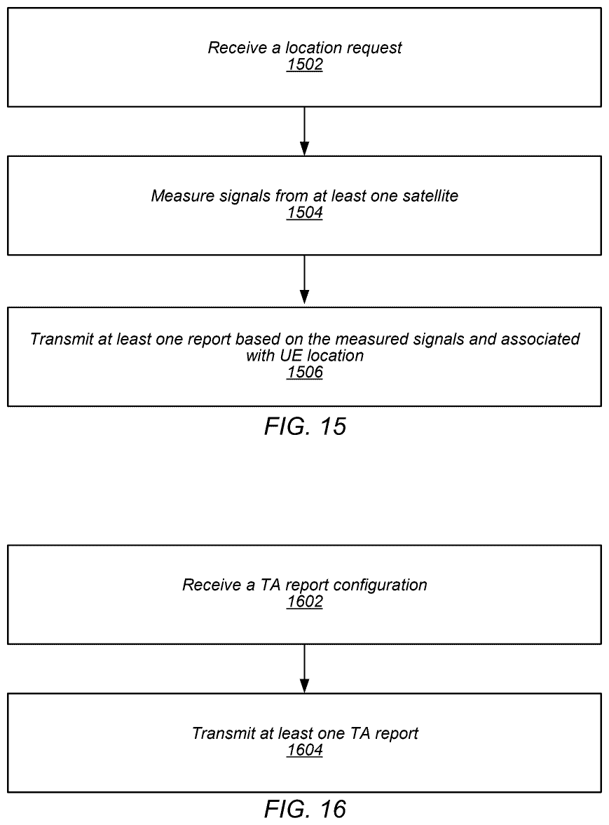

FIG. 15 illustrates a block diagram of a further example of a method for determining UE location in a non-terrestrial network (NTN), according to some embodiments. The method shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1502, a UE, such as UE 106, may receive, from a network entity, e.g., such as base station 102 and/or LMF 609, a location request.

At 1504, the UE may measure signals from at least one satellite.

At 1506, the UE may transmit, to the network entity, at least one report based on the measuring of the signals and associated with UE location. In some instances, the at least one report may include Reference Signal Time Difference (RSTD) measurements of at least two DL-PRS transmissions. In some instances, the RSTD measurements may be based, at least in part, on a timing difference of the two DL-PRS transmissions. In some instances, the DL-PRS transmissions may be received from one satellite (e.g., the same satellite) and/or one transmit-receive point (TRP) (e.g., the same TRP). In some instances, the at least one report may include three or more reports and each report of the three or more reports may include a Reference Signal Time Difference (RSTD) measurement. In some instances, the at least one report may include UE mobility information. In some instances, the at least one report may include Reference Signal Time Difference (RSTD) measurements from at least three satellites. In some instances, the at least one report may include three or more timing advance reports.

In some instances, the UE, may receive, from the network entity, assistance data. The assistance data may indicate a time sequence for the UE to measure downlink position reference signals (DL-PRSs).

FIG. 16 illustrates a block diagram of a yet further example of a method for determining UE location in a non-terrestrial network (NTN), according to some embodiments. The method shown in FIG. 16 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1602, a UE, such as UE 106, may receive, from a network entity, e.g., such as base station 102 and/or LMF 609, a timing advance report configuration. The timing advance report configuration may include satellite location information. The timing advance report configuration may include timing information requirements for the at least one timing advance report. The timing information requirements may include one or more of a periodicity or an offset.

At 1604, the UE may transmit, to the network entity, at least one timing advance report. The at least one timing advance report may be comprised and/or included in a medium access control (MAC) control element (CE). The at least one timing advance report may include three or more timing advance reports.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for determining user equipment (UE) location in a non-terrestrial network (NTN), comprising:
a network entity,
transmitting a location request to a user equipment (UE);
receiving at least one report from the UE associated with UE location; and
calculating, based on the at least one report, UE location.

2. The method of claim 1, further comprising:
transmitting assistance data to the UE, wherein the assistance data indicates a time sequence for a UE to measure downlink position reference signals (DL-PRSs).

3. The method of claim 2,
wherein the time sequence includes, for each configured DL-PRS transmission a valid time period for the UE to measure an associated DL-PRS.

4. The method of claim 1,
wherein the at least one report includes Reference Signal Time Difference (RSTD) measurements of at least two DL-PRS transmissions.

5. The method of claim 4,
wherein the RSTD measurements are based, at least in part, on a timing difference of the two DL-PRS transmissions.

6. The method of claim 5,
wherein the DL-PRS transmissions are received from one satellite or one transmit-receive point (TRP).

7. The method claim 1,
wherein the at least one report includes three or more reports.

8. The method of claim 7,
wherein each report of the three or more reports includes a Reference Signal Time Difference (RSTD) measurement.

9.-21. (canceled)

22. An apparatus, comprising:
a memory; and
processing circuitry in communication with the memory and configured to:
transmit a location request to a user equipment (UE) in a non-terrestrial network (NTN);
receive at least one report from the UE associated with UE location; and
calculate, based on the at least one report, UE location.

23. The apparatus of claim 22,
wherein the at least one report includes UE mobility information.

24. The apparatus of claim 23,
wherein the processing circuitry is further configured to:
increase UE location accuracy based, at least in part, on incorporating UE mobility information into the calculation of UE location.

25. The apparatus of claim 22,
wherein the at least one report includes Reference Signal Time Difference (RSTD) measurements from at least three satellites.

26. The apparatus of claim 25,
wherein the processing circuitry is further configured to:
request, from a base station, transmit receive point (TRP) information; and
receive, from the base station, the TRP information.

27. The apparatus of claim 26,
wherein the TRP information includes satellite ephemeris information.

28. The apparatus of claim 22,
wherein the at least one report includes three or more timing advance reports.

29. The apparatus of claim 28,
wherein the processing circuitry is further configured to:
request, from a base station, satellite location information.

30. The apparatus of claim 29,
wherein calculating the UE location is further based, at least in part, on the satellite location information.

31. A non-transitory computer readable memory medium storing instructions executable by processing circuitry to cause a network entity to:
transmit a location request to a user equipment (UE) in a non-terrestrial network (NTN);
receive at least one report from the UE associated with UE location; and
calculate, based on the at least one report, UE location.

32. The non-transitory computer readable memory medium of claim 31,
wherein the network entity comprises a server.

33. The non-transitory computer readable memory medium of claim 32,
wherein the server hosts a location management function.
